(19) United States
(12) Patent Application Publication
(10) Pub. No.: US 2024/0227437 A1
(43) Pub. Date: Jul. 11, 2024

(54) VEHICLE WHEEL

(71) Applicant: TOYOTA JIDOSHA KABUSHIKI KAISHA, Toyota-shi (JP)

(72) Inventor: Yutaka HIRANO, Toyota-shi (JP)

(21) Appl. No.: 18/516,796

(22) Filed: Nov. 21, 2023

(30) Foreign Application Priority Data
Jan. 10, 2023 (JP) 2023-001931

(51) Int. Cl. B60B 19/10; B60B 25/22

(52) U.S. Cl. CPC B60B 19/10; B60B 25/22

(57) ABSTRACT

A vehicle wheel, includes: a rim part at which a tire is mounted; a hub part disposed at an inner side of the rim part, attached to an axle hub, and coupled to a disc rotor of a disc brake; and a side connection part configured to connect a vehicle outer side part of the rim part with the hub part, in which: in an axle direction view, between the rim part and the hub part, plural through holes penetrating in the axle direction are formed aligned in a circumferential direction, and plural fins are formed at an inner peripheral surface of the rim part in series in a row in a circumferential direction thereof, each of the fins being configured at an incline from an outer side to an inner side in the wheel axis direction toward one side in the circumferential direction of the rim part.

### CROSS-REFERENCE TO RELATED APPLICATION

This application is based on and claims priority under 35 USC 119 from Japanese Patent Application No. 2023-001931, filed on Jan. 10, 2023, the disclosure of which is incorporated by reference herein.

### BACKGROUND

### Technical Field

The present disclosure relates to a vehicle wheel.

### Related Art

Various techniques relating to vehicle wheels are known (for example, Japanese Patent Application Laid-open (JP-A) No. S59-143701, JP-A No. 2020-203578, and JP-A No. 2022-110733). For example, JP-A No. S59-143701 discloses a technique in which plural through holes are formed in a side portion of the wheel, and plural cooling fins are provided in a protruding manner on a rear surface portion of the wheel so as to discharge air inside the wheel from the through holes during rotation of the wheel. In such technology, the airflow can cool a brake disc (disc rotor of a disc brake).

However, since the airflow generated in this conventional technique also includes an airflow that does not pass near the brake disc but passes between the cooling fins on the rear surface of the wheel and through the holes (airflow that does not act to cool the brake disc), there is room for improvement from the standpoint of further cooling the brake disc.

### SUMMARY

In consideration of the above facts, the present disclosure obtains a vehicle wheel capable of efficiently cooling a disc rotor of a disc brake using an airflow.

A vehicle wheel of a first aspect includes: a rim part at which a tire is mounted; a hub part disposed at an inner side of the rim part, attached to an axle hub, and coupled to a disc rotor of a disc brake; and a side connection part configured to connect a vehicle outer side part of the rim part with the hub part, wherein: in an axle direction view, between the rim part and the hub part, plural through holes penetrating in the axle direction are formed and are aligned in a circumferential direction, and plural fins are formed at an inner peripheral surface of the rim part in series in a row in a circumferential direction thereof, each of the fins being configured at an incline from an outer side in a wheel axis direction to an inner side in the wheel axis direction toward one side in the circumferential direction of the rim part. Note that the “outer side in the wheel axis direction” refers to the outer side of the vehicle in the wheel axis direction, and the “inner side in the wheel axis direction” refers to the inner side of the vehicle in the wheel axis direction.

According to the above configuration, a tire is mounted on the rim part, and a hub part disposed at an inner side of the rim part is attached to an axle hub, and a disc rotor of a disc brake is connected thereto. Moreover, the vehicle outer side part of the rim part and the hub part are held together by a side connection part, and plural through holes are formed and are aligned in a circumferential direction between the rim part and the hub part in an axle direction view. Note that fins are provided on an inner peripheral surface of the rim part so as to be aligned in series in a row in a circumferential direction, and the fins are configured so as to be inclined toward one side in a circumferential direction of the rim part from an outer side in a wheel axis direction to an inner side in a wheel axis direction. For this reason, in cases in which the vehicle wheels rotate during vehicle travel, the fins efficiently push out air to one side in the wheel axis direction, thereby lowering the air pressure at the inner peripheral side of the rim part, enabling an airflow from the center side of the disk rotor toward the outer peripheral side of the disk rotor to be effectively formed. This enables the disk rotor to be efficiently cooled. Moreover, since the fins are aligned in a row in series in the circumferential direction of the rim part, design to optimize airflow during rotation of the vehicle wheel is facilitated.

A vehicle wheel of a second aspect is the first aspect, in which a position of each of the fins in the wheel axis direction overlaps with a position in a width direction of a pressed part of the disc rotor that is configured to be pressed by a brake pad, and a width of each of the fins in the wheel axis direction is wider than a width of the pressed part of the disc rotor.

According to the above configuration, since the air pressure at the inner peripheral side of the rim part and at the outer peripheral side of the pressed part of the disk rotor can be efficiently reduced, airflow from the center side of the disk rotor toward the outer peripheral side of the pressed part of the disk rotor can be formed more effectively.

A vehicle wheel of a third aspect is the first aspect, in which each of the fins is configured at an incline from the outer side in the wheel axis direction to the inner side in the wheel axis direction toward an opposite side from a wheel rotation direction side during vehicle forward movement, in the circumferential direction of the rim part.

According to the above configuration, since the fins can efficiently push air inward in the vehicle width direction when the vehicle wheel rotates during vehicle forward movement, airflow passing through the vehicle wheel outward in the vehicle width direction can be suppressed. This enables air resistance during vehicle forward travel to be suppressed.

A vehicle wheel of a fourth aspect is the third aspect, in which the fins are disposed at positions in the wheel circumferential direction of the inner peripheral surface of the rim part corresponding to the plural through holes.

According to the above configuration, in cases in which the vehicle wheel rotates during vehicle forward movement, airflow that passes through the plural through holes of the vehicle wheel outward in the vehicle width direction can be further effectively suppressed.

As described above, the vehicle wheel of the present disclosure exhibits the effect of enabling the disc rotor of the disc brake to be efficiently cooled by airflow.

### BRIEF DESCRIPTION OF THE DRAWINGS

An exemplary embodiment of the present disclosure will be described in detail based on the following FIGURES, wherein:

FIG. 1 is a side view illustrating a front part of a vehicle to which a vehicle wheel according to an exemplary embodiment of the present disclosure is applied;

FIG. 2 is an enlarged cross-sectional view taken along line 2-2 of FIG. 1;

FIG. 3 is a perspective view that is a vehicle width direction inner side obliquely rearward view schematically illustrating a state in which a tire is mounted on the wheel illustrated in FIG. 1;

FIG. 4 is an enlarged cross-sectional view of a front part side of FIG. 2;

FIG. 5 is a diagram illustrating a state of pressure distribution of air around an outer periphery of a disc rotor when the vehicle of FIG. 1 is moving forward, as viewed from a side of the vehicle; and

FIG. 6 is a diagram illustrating a state of pressure distribution of air around an outer periphery of a disc rotor when a comparative example is moving forward, as viewed from a side of the vehicle.

### DETAILED DESCRIPTION

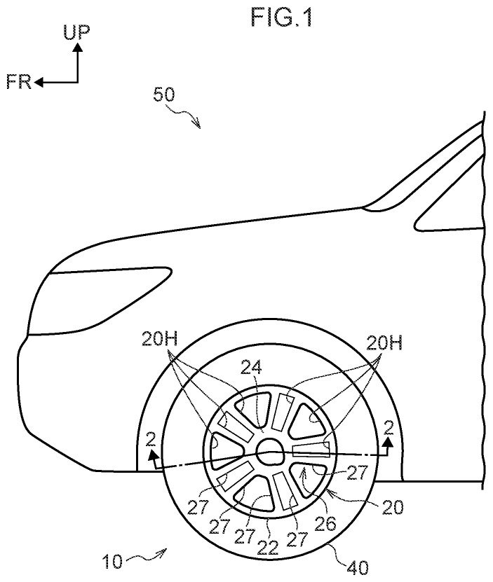

Explanation follows regarding a vehicle wheel according to an exemplary embodiment of the present disclosure, with reference to FIG. 1 to FIG. 6. Note that in these drawings, the arrow FR illustrated as appropriate indicates a front side of the vehicle, the arrow UP indicates an upper side of the vehicle, and the arrow OUT indicates an outer side in the vehicle width direction.

### Configuration of Exemplary Embodiment

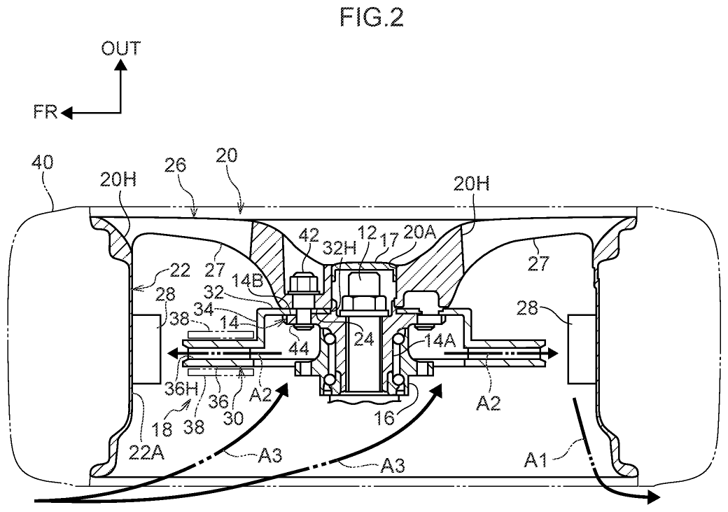

FIG. 1 is a side view illustrating a portion (front portion) of a vehicle 50 to which a vehicle wheel 20 (hereafter abbreviated as the “wheel 20”) according to the present exemplary embodiment is applied. As illustrated in FIG. 1, the vehicle 50 includes wheel (wheel with tire attached) 10 configured by including a wheel 20 and a tire 40 mounted on the wheel 20. FIG. 2 is an enlarged cross-sectional view taken along line 2-2 of FIG. 1.

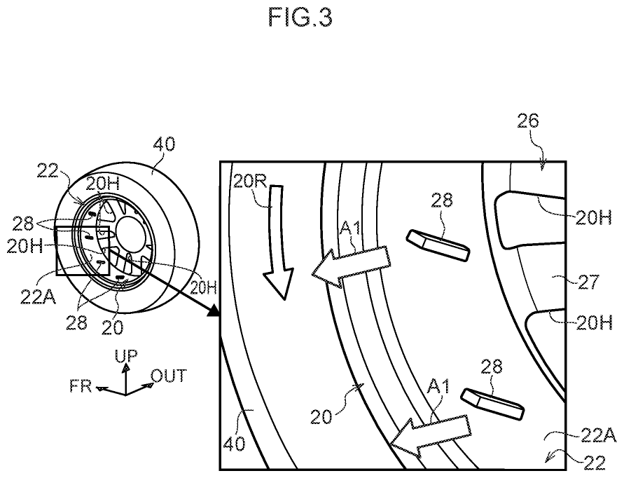

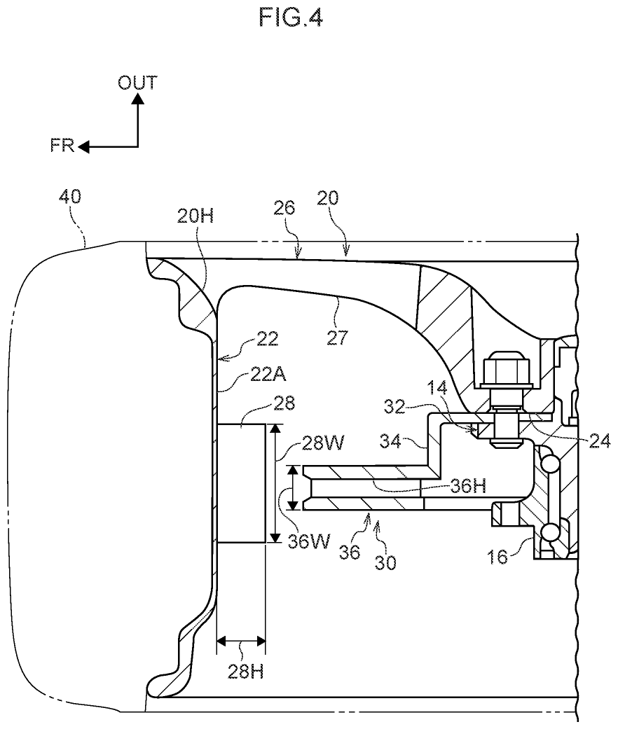

As illustrated in FIG. 2, the wheel 20 is supported by an axle 12 (only a portion of the distal end side is illustrated). Note that in FIG. 2, the respective axial directions of the axle 12 and the wheel 20 and the vehicle width direction are the same direction (the same applies to FIG. 3 and FIG. 4). A wheel cap 17 is attached to an opening 20A in a central portion of the wheel 20 at an outer side in the wheel axis direction (on the same side as the outer side in the vehicle width direction in the drawings), and the wheel cap 17 covers the distal end of the axle 12. An axle hub 14 is disposed at an outer peripheral portion of the axle 12. The axle hub 14 includes a cylindrical shaft part 14A whose axial direction is the axle direction, and an annular flange part 14B extending radially outward from an outer end side of the shaft part 14A in the axle direction. The axle hub 14 is fixed to the axle 12 in a state in which the shaft part 14A is disposed at an outer peripheral portion of the axle 12. A knuckle (not illustrated) is connected to an outer peripheral portion of the shaft part 14A of the axle hub 14 via a bearing 16.

The wheel 20 includes a rim part 22 at which the tire 40 is attached, a hub part 24 disposed at an inner side of the rim part 22 and attached to the axle hub 14, and a side connection part 26 that links the vehicle outer side part of the rim part 22 to the hub part 24. Note that in FIG. 2, for the sake of simplicity, only the outer shape of the tire 40 excluding the portion in contact with the rim part 22 is illustrated by the two-dot chain line (the same applies to FIG. 4). As illustrated in FIG. 1, the side connection part 26 is configured by plural spoke parts 27, and the spoke parts 27 extend substantially radially from the hub part 24 to the rim part 22. As a result, the wheel 20 is formed with plural through holes 20H penetrating in the axial direction between the rim part 22 and the hub part 24 as viewed in the axial direction, the through holes 20H being aligned in the circumferential direction.

As illustrated in FIG. 2, the rim part 22 is formed in a substantially cylindrical shape, and the tire 40 is mounted onto an outer peripheral surface side thereof. The rim part 22 may be configured by a single member or may be configured by joining an inner rim and an outer rim together. The configuration of the inner peripheral surface 22A side of the rim part 22 is described later. The hub part 24 is provided at a rotational center part of the wheel 20, and is disposed at an outer side of the vehicle relative to a central part in the wheel axis direction in the wheel 20. The annular flange part 14B of the axle hub 14 is disposed at an inner side of the hub part 24 in the wheel axis direction (the same side as the inner side in the vehicle width direction in the drawings), and the flange part 14B of the axle hub 14 is attached to the hub part 24 using a bolt 42 and a nut 44.

The hub part 24 is connected to a disk rotor 30 disposed at an inner side of the rim part 22. The disc rotor 30 is a substantially disc-shaped member that configures a part of a disc brake (also referred to as a “disc brake device”) 18 and rotates integrally with the wheel 20.

The disc rotor 30 includes an annular part 32 partially disposed between the hub part 24 of the wheel 20 and the flange part 14B of the axle hub 14. The annular part 32 is fastened together with the hub part 24 of the wheel 20 and the flange part 14B of the axle hub 14 using the bolt 42 and the nut 44. Moreover, the disk rotor 30 includes a cylindrical part 34 extended in a cylindrical shape from an outer peripheral end of the annular part 32 toward the inner side in the vehicle width direction, and an annular pressed part 36 extended radially outward from an open side end part side of the cylindrical part 34. A central hole 32H is formed through a central portion of the annular part 32, and a through hole 36H is formed in the pressed part 36 so as to penetrate from a central region side toward an outer periphery side. The through hole 36H is formed so as to be aligned in the circumferential direction of the pressed part 36.

The disc brake 18 including the disc rotor 30 includes a brake caliper (not illustrated in the drawings as a whole), and this brake caliper includes a brake pad 38 (illustrated in the drawings with two-dot chain lines for simplicity) and a piston (not illustrated). In a case in which a brake operation is performed in the vehicle 50 (see FIG. 1), the brake pad 38 is pressed against the pressed part 36 of the disc rotor 30 by the piston. Note that a well-known configuration is applied to the disc brake 18 and, therefore, detailed explanation thereof is omitted.

FIG. 3 is a simplified perspective view illustrating a state in which the tire 40 is mounted on the wheel 20 illustrated in FIG. 1. As illustrated in FIG. 3, the inner peripheral surface 22A of the rim part 22 is provided with plural fins 28 aligned in series in a row in the circumferential direction thereof. The fins 28 are rectangular plate-shaped protrusions, and are set at positions in a wheel circumferential direction on the inner peripheral surface 22A of the rim part 22 corresponding to the plural through holes 20H. As an example, the fins 28 are formed separately from the wheel 20, and are joined to the inner peripheral surface 22A of the rim part 22.

The fins 28 are set so as to be inclined toward one side in the circumferential direction of the rim part 22 from an outer side in the wheel axis direction (on the same side as the outer side in the vehicle width direction in the drawings) to an inner side in the wheel axis direction (the same side as the inner side in the vehicle width direction in the drawings). More specifically, the fins 28 are set so as to be inclined from the outer side in the wheel axis direction to the inner side in the wheel axis direction toward an opposite side from the wheel rotation direction side during vehicle forward movement (direction in which the wheel 20 rotates (see arrow 20R)) in the circumferential direction of the rim part 22. The inclination angle of the fin 28 with respect to the wheel axis direction is preferably 15° to 60°, and in the present exemplary embodiment is set to 30°, for example.

FIG. 4 is an enlarged cross-sectional view of the front part side of FIG. 2. As illustrated in FIG. 4, the position of the fin 28 in the wheel axis direction is set at a position overlapping with the position in the width direction (the same direction as the vehicle width direction in FIG. 4) of the pressed part 36 of the disk rotor 30. In other words, the fins 28 are set at positions that oppose the pressed part 36 of the disk rotor 30 in the rotor radial direction (the radial direction of the disk rotor 30). The width 28W of the fin 28 in the wheel axis direction is set wider than the width 36W of the pressed part 36 of the disk rotor 30, and in the present exemplary embodiment, is set to 72 mm as an example. The protrusion height 28H of the fin 28 is preferably set to 10 mm or more, and in the present exemplary embodiment is set to 12 mm as an example. Needless to say, the protrusion height 28H of the fins 28 is set on the basis that the fins 28 do not interfere with the disk rotor 30.

### Mechanism and Effects of Exemplary Embodiment

Next, explanation follows regarding the mechanism and effects of the present exemplary embodiment.

In the present exemplary embodiment, as illustrated in FIG. 3, the inner peripheral surface 22A of the rim part 22 is provided with fins 28 aligned in a row in the circumferential direction thereof, and the fins 28 are set so as to be inclined toward one side in the circumferential direction of the rim part 22 from an outer side in the wheel axis direction to an inner side in the wheel axis direction. Accordingly, in a case in which the wheel 20 rotates during driving of the vehicle, the fins 28 efficiently push air out to one side in the wheel axis direction (see arrow A1), thereby lowering the air pressure at the inner peripheral side of the rim part 22, enabling the airflow (cooling air, see arrow A2) from the center side of the disk rotor 30 toward the outer peripheral side of the disk rotor 30, illustrated in FIG. 2, to be effectively formed. This enables the disk rotor 30 to be efficiently cooled. Moreover, since the fins 28 are arranged in series in a row in a circumferential direction of the rim part 22, it is easy to design so as to optimize airflow during rotation of the wheel 20. Note that the arrow A3 in FIG. 2 indicates the flow of air guided from the front side below the vehicle floor to the center side of the disk rotor 30 in conjunction with the above mechanism.

As illustrated in FIG. 3, the direction of inclination of the fins 28 is, more specifically, a direction that is inclined from the outer side in the wheel axis direction to the inner side in the wheel axis direction toward an opposite side from the wheel rotation direction during vehicle forward movement (see arrow 20R) in the circumferential direction of the rim part 22. Accordingly, in the present exemplary embodiment, in a case in which the wheel 20 rotates during forward movement of the vehicle 50 (see FIG. 1), since the fins 28 can efficiently push air inward in the vehicle width direction (see arrow A1), airflow that passes through the through holes 20H of the wheel 20 outward in the vehicle width direction can be suppressed. This enables air resistance during forward movement of the vehicle 50 (see FIG. 1) to be suppressed (thus not impairing aerodynamic performance).

Further, as illustrated in FIG. 4, the position of the fin 28 in the wheel axis direction is set at a position that overlaps with the position of the pressed part 36 of the disk rotor 30 in the width direction, and the width 28W of the fin 28 in the wheel axis direction is set wider than the width 36W of the pressed part 36 of the disk rotor 30. This enables the air pressure at the inner peripheral side of the rim part 22 and at the outer peripheral side of the disk rotor 30 to be efficiently reduced, and therefore, as illustrated in FIG. 2, it is possible to more effectively form an airflow (see arrow A2) from the center side of the disk rotor 30 toward the outer peripheral side of the pressed part 36 of the disk rotor 30.

Moreover, as illustrated in FIG. 3, the fins 28 are set at positions in the wheel circumferential direction on the inner peripheral surface 22A of the rim part 22 corresponding to the plural through holes 20H. Accordingly, in a case in which the wheel 20 rotates during forward movement of the vehicle 50 (see FIG. 1), airflow that passes through the plural through holes 20H of the wheel 20 outward in the vehicle width direction can be more effectively suppressed.

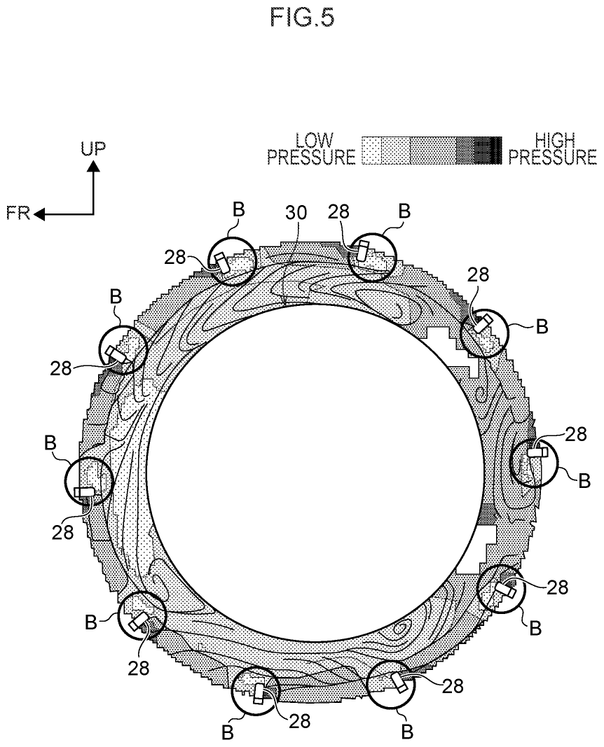

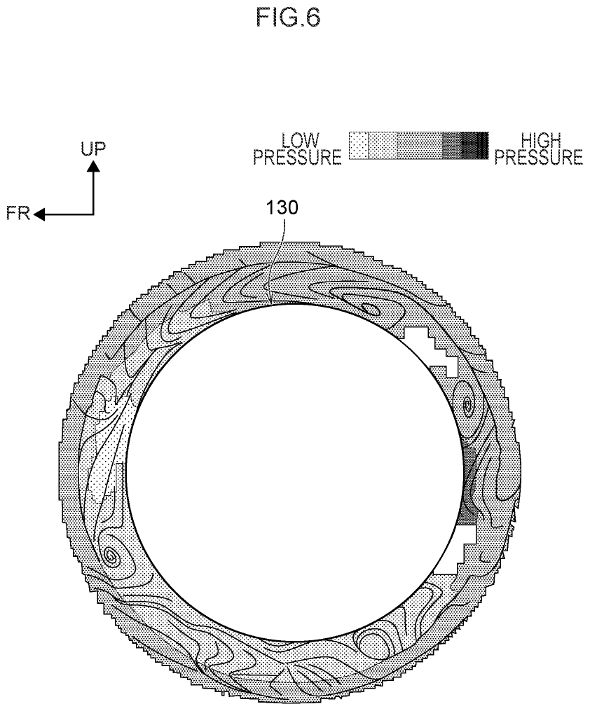

Explanation follows briefly regarding the pressure distribution of air on the outer peripheral side of the disk rotor 30. FIG. 5 is a diagram illustrating a state in which a pressure distribution of air on an outer peripheral side of the disc rotor 30 (schematically illustrated in the drawings in a circular shape) during forward movement of the vehicle 50 (see FIG. 1) is viewed from a side of the vehicle. FIG. 6 is a diagram illustrating a state in which a pressure distribution of air on an outer peripheral side of a disk rotor 130 (schematically illustrated in the drawings in a circular shape) during forward movement of a vehicle of a comparative example is viewed from a side of the vehicle.

The vehicle of the comparative example is similar in configuration to the vehicle 50 of the present exemplary embodiment, with the exception that the fins 28 of the present exemplary embodiment are not included. Note that although the reference numeral of the disk rotor in the comparative example is changed from that of the disk rotor 30 of the present exemplary embodiment, with the reference numeral 130 allocated for simplicity, the configuration thereof is similar to that of the disk rotor 30 of the present exemplary embodiment. In FIG. 5 and FIG. 6, the higher the pressure of the air around the outer peripheries of the disc rotors 30, 130, the greater the dot density of the illustration.

As illustrated in FIG. 5, it is evident that in the present exemplary embodiment, a region in which the air pressure is low is formed downstream of the fin 28 in the rotational direction (see the portions enclosed by the circles B). As illustrated in FIG. 5 and FIG. 6, it can be seen that in the present exemplary embodiment (see FIG. 5), overall, there are more regions in which the air pressure is lower than in the comparative example (see FIG. 6).

In the case of the present exemplary embodiment illustrated in FIG. 5, the reason that, overall, there are more regions in which the air pressure is low is that regions in which the air pressure is low are formed downstream of the fins 28 in the rotational direction. Moreover, if a region in which the air pressure is low is formed downstream of the fins 28 in the rotational direction, the amount of air flowing from the center side of the disk rotor 30 toward the outer peripheral side of the disk rotor 30 increases, enabling the disk rotor 30 to be efficiently cooled. Note that in the present exemplary embodiment, the heat transfer coefficient is increased by a factor of 1.2 with respect to the heat transfer coefficient of the comparative example, and the performance as regards cooling the disc rotor 30 is greatly improved.

As described above, the wheel 20 of the present exemplary embodiment illustrated in FIG. 1 to FIG. 4 enables the disc rotor 30 of the disc brake to be efficiently cooled by the airflow. Moreover, in the present exemplary embodiment, there is no increase in air resistance during forward movement of the vehicle 50 (see FIG. 1). Moreover, since the fins 28 are set at positions that are not visible, their influence on the aspect of design can be suppressed.

### Supplementary Explanation of Exemplary Embodiments

Note that in the above exemplary embodiment, as illustrated in FIG. 3, the fins 28 are set so as to be inclined from the outer side in the wheel axis direction to the inner side in the wheel axis direction toward the opposite side from the wheel rotation direction (see arrow 20R) side during vehicle forward movement in the circumferential direction of the rim part 22, and although such a configuration is preferable, as a modified example of the above exemplary embodiment, a configuration may be adopted in which the fins are set so as to be inclined from the outer side in the wheel axis direction to the inner side in the wheel axis direction toward the wheel rotation direction (see arrow 20R) side during vehicle forward movement, in the circumferential direction of the rim part 22.

In the above exemplary embodiment, as illustrated in FIG. 4, the width 28W of the fin 28 in the wheel axis direction is set wider than the width 36W of the pressed part 36 of the disk rotor 30, and although such a configuration is preferable, as a modified example of the above exemplary embodiment, a configuration may be adopted in which the width of the fin in the wheel axis direction is set equal to or less than the width 36W of the pressed part 36 of the disk rotor 30.

Moreover, in the above exemplary embodiment, the position of the fin 28 in the wheel axis direction is set at a position that overlaps with the position of the pressed part 36 of the disk rotor 30 in the width direction, and although such a configuration is preferable, as a modified example of the above exemplary embodiment, a configuration may be adopted in which the position of the fin in the wheel axis direction is set at a position that does not overlap with the position of the pressed part 36 of the disk rotor 30 in the width direction.

Moreover, in the above exemplary embodiment, as illustrated in FIG. 3, the fins 28 are set at positions in the wheel circumferential direction on the inner peripheral surface 22A of the rim part 22 corresponding to the plural through holes 20H, and although such a configuration is preferable, as a modified example of the above exemplary embodiment, a configuration may be adopted in which the fins are set at a position displaced from positions in the wheel circumferential direction on the inner peripheral surface 22A of the rim part 22 corresponding to the through holes 20H.

Although in the above exemplary embodiment, the fins 28 are rectangular plate-shaped projections, the fins may be, for example, a quadrilateral other than a rectangle, triangular, polygonal with a five sides or more, or circular in side view, and may be for example, a quadrilateral other than a rectangle, triangular, polygonal with a five sides or more, or circular in plan view.

Although in the exemplary embodiment described above, the side connection part 26 is configured by plural spoke parts 27, the side connection part may be configured by, for example, a panel part that does not include the plural spoke parts 27, but that is annular in shape and that includes plural through holes formed aligned in the circumferential direction and penetrating in the axle direction.

Note that the above exemplary embodiment and the plural modified examples described above may be implemented in appropriate combinations.

Although examples of the present disclosure have been described above, the present disclosure is not limited to the above description, and obviously various other modifications

What is claimed is:

1. A vehicle wheel, comprising:
a rim part at which a tire is mounted;
a hub part disposed at an inner side of the rim part, attached to an axle hub, and coupled to a disc rotor of a disc brake; and
a side connection part configured to connect a vehicle outer side part of the rim part with the hub part, wherein:
in an axle direction view, between the rim part and the hub part, a plurality of through holes penetrating in the axle direction are formed and are aligned in a circumferential direction, and
a plurality of fins are formed at an inner peripheral surface of the rim part, in series, in a row in a circumferential direction thereof, each of the fins being configured at an incline from an outer side in a wheel axis direction to an inner side in the wheel axis direction toward one side in the circumferential direction of the rim part.

2. The vehicle wheel of claim 1, wherein a position of each of the fins in the wheel axis direction overlaps with a position in a width direction of a pressed part of the disc rotor that is configured to be pressed by a brake pad, and a width of each of the fins in the wheel axis direction is wider than a width of the pressed part of the disc rotor.

3. The vehicle wheel of claim 1, wherein each of the fins is configured at an incline from the outer side in the wheel axis direction to the inner side in the wheel axis direction toward an opposite side from a wheel rotation direction side during vehicle forward movement, in the circumferential direction of the rim part.

4. The vehicle wheel of claim 3, wherein the fins are disposed at positions in the wheel circumferential direction of the inner peripheral surface of the rim part corresponding to the plurality of through holes. may the implemented within a range not departing from the gist of the present disclosure.
